(19) United States
(12) Patent Application Publication
(10) Pub. No.: US 2015/0164070 A1
(43) Pub. Date: Jun. 18, 2015

(54) INFLUENZA VIRUS INFECTION INHIBITOR FOR FIBER PROCESSING, FIBER PRODUCT USING THE SAME, AND METHOD FOR PRODUCING THE SAME

(71) Applicants: Sekisui Chemical Co., Ltd., Osaka (JP); Sekisui-Polymatech Co., Ltd., Tokyo (JP)

(72) Inventors: Takayuki Akamine, Osaka (JP); Akihiko Fujiwara, Osaka (JP); Taro Suzuki, Osaka (JP)

(21) Appl. No.: 14/387,982

(22) PCT Filed: Mar. 26, 2013
(86) PCT No.: PCT/JP2013/058781

§ 371 Date: Sep. 25, 2014

(30) Foreign Application Priority Data
Mar. 27, 2012 (JP) 2012-070651

(51) Int. Cl. A01N 41/04; D06M 16/00

(52) U.S. Cl. CPC A01N 41/04; D06M 16/00; D06M 2101/32

(57) ABSTRACT

The present invention provides an influenza virus infection inhibitor for fiber processing that can inhibit effectively an influenza virus from infecting a human and thereby prevent onset of a symptom or, if any symptom occurs, aim at alleviation of the symptom, and has an excellent rubbing fastness.

The influenza virus infection inhibitor for fiber processing is characterized by containing a compound that inhibits influenza virus infection, wherein the compound has at least one of substituents with structural formulae represented by the general formulae (1) to (3) on a side chain of a linear macromolecule and contains not less than 70% by weight of a monomer component having at least one of the substituent with the structural formulae represented by the general formulae (1) to (3).

### TECHNICAL FIELD

The present invention relates to an influenza virus infection inhibitor for fiber processing, a fiber product that inhibits influenza virus infection and a method for producing the same, and use of a compound as an influenza virus infection inhibitor for fiber processing.

### BACKGROUND ART

In recent years, in addition to an epidemic of a seasonal influenza, a highly pathogenic avian influenza virus has mutated and infection from human to human has occurred, and a pandemic thereof is of concerns.

As reoccurrence of a very highly deadly SARS virus is also of concern, there is more and more anxiety about a highly pathogenic influenza virus.

To address these issues, Patent Literature 1, by way of example, discloses an antiviral fiber that supports an antiviral agent on the fiber, wherein the antiviral agent is effective against an influenza virus and includes metal phthalocyanine having a specific structure.

Furthermore, Patent Literature 2 discloses a method for producing a cellulosic fiber or a fiber product that has the ability to inactivate a norovirus, the method including attaching a water-soluble phenolic resin and a cross-linking agent to the cellulosic fiber or the fiber product and subjecting it to a heat treatment.

Furthermore, Patent Literature 3 discloses an antiviral agent that contains, as an active ingredient, a sulfonated polymer in which a carbon atom of a chain macromolecule having an aliphatic compound as a main chain is directly sulfonated and discloses that the antiviral agent suppresses cell destruction by an HIV, suppresses formation of a giant cell caused by an HIV, and has an inhibitory activity against a reverse transcriptase of an HIV.

However, in the antiviral agent disclosed in Patent Literature 1, there arises a problem in that it ruins the original color of a fiber, since the antiviral agent has a color such as blue or green derived from a phthalocyanine complex. The cellulosic fiber or the fiber product in Patent Literature 2 and the antiviral agent disclosed in Patent Literature 3 are not effective against an influenza virus.

### CITATION LIST

### Patent Literature

Patent Literature 1: Japanese Patent Application Laid-Open No. 2010-30983
Patent Literature 2: Japanese Patent Application Laid-Open No. 2009-150021
Patent Literature 3: Japanese Patent Application Laid-Open No. Hei 5-139981

### SUMMARY OF INVENTION

### Technical Problem

The present invention provides an influenza virus infection inhibitor for fiber processing; a fiber product that inhibits influenza virus infection produced by treatment with this influenza virus infection inhibitor for fiber processing; a method for producing the fiber product that inhibits influenza virus infection; and use of a compound as an influenza virus infection inhibitor. The above-described influenza virus infection inhibitor for fiber processing can effectively inhibit an influenza virus from infecting a human and thereby prevent onset of a symptom or, if any symptom occurs, aim at alleviation of the symptom, and additionally has an excellent rubbing fastness.

### Solution to Problem

The influenza virus infection inhibitor for fiber processing of the present invention is characterized by containing a compound that inhibits influenza virus infection, wherein the compound has at least one of substituents with structural formulae represented by the respective general formulae (1) to (3) on a side chain of a linear macromolecule and contains not less than 70% by weight of a monomer component having at least one of the substituents with the structural formulae represented by the general formulae (1) to (3):

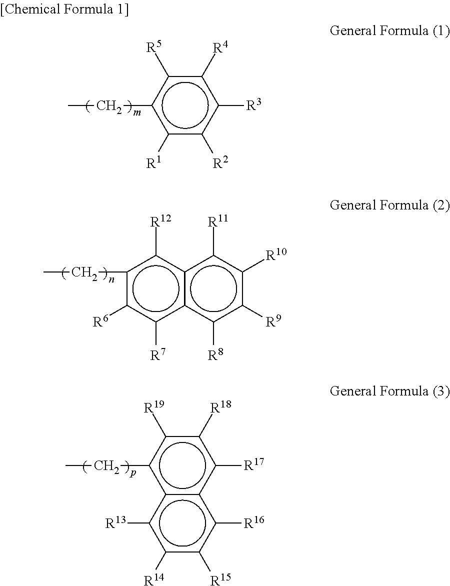

wherein m, n, and p each represent an integer of 0 to 2; R¹ to R¹⁹ each are any of hydrogen, a carboxy group, a sulfonic acid group, a carboxy group in salt form, a sulfonic acid group in salt form, a derivatized carboxy group, and a derivatized sulfonic acid group; at least one of R¹ to R⁵ is a carboxy group, a sulfonic acid group, a carboxy group in salt form, a sulfonic acid group in salt form, a derivatized carboxy group, or a derivatized sulfonic acid group; at least one of R⁶ to R¹² is a carboxy group, a sulfonic acid group, a carboxy group in salt form, a sulfonic acid group in salt form, a derivatized carboxy group, or a derivatized sulfonic acid group; and at least one of R¹³ to R¹⁹ is a carboxy group, a sulfonic acid group, a carboxy group in salt form, a sulfonic acid group in salt form, a derivatized carboxy group, or a derivatized sulfonic acid group.

In this context, “an influenza virus infection inhibitor for fiber processing” means a substance that has an effect of inhibiting influenza virus infection. The phrase “an effect of inhibiting influenza virus infection” means an effect that disables an influenza virus that exists in a fiber product from infecting a cell or disables an influenza virus that has separated from a fiber product from growing in a cell after infecting the cell. Examples of methods for determining the presence or absence of infectivity of such an influenza virus include those described in “medical pharmaceutical virology” (the first edition was published in April 1990), such as a plaque assay or a hemagglutination unit (HAU) assay.

Examples of influenza viruses that are targets of the influenza virus infection inhibitor for fiber processing according to the present invention may include human parainfluenza viruses 1 and 3 and human parainfluenza viruses 2 and 4 belonging to the Paramyxoviridae family, and an influenza A virus, an influenza B virus, and an influenza C virus belonging to the Orthomyxoviridae family.

In the above-described general formulae (1) to (3), m, n, and p each represent an integer of 0 to 2. This is because the compound with m, n, and p being 3 or more that should inhibit influenza virus infection loses its effect of inhibiting influenza virus infection.

Furthermore, in the general formula (1), R¹ to R⁵ each represent, independently of each other, any of hydrogen (—H), a carboxy group (—COOH), a sulfonic acid group (—SO₃H), a carboxy group in salt form, a sulfonic acid group in salt form, a derivatized carboxy group, and a derivatized sulfonic acid group, provided that at least one of R¹ to R⁵ needs to be a carboxy group (—COOH), a sulfonic acid group (—SO₃H), a carboxy group in salt form, a sulfonic acid group in salt form, a derivatized carboxy group, or a derivatized sulfonic acid group. R¹ to R⁵ may be identical to each other or different from each other.

Similarly, in the general formula (2), R⁶ to R¹² each represent, independently of each other, any of hydrogen (—H), a carboxy group (—COOH), a sulfonic acid group (—SO₃H), a carboxy group in salt form, a sulfonic acid group in salt form, a derivatized carboxy group, and a derivatized sulfonic acid group, provided that at least one of R⁶ to R¹² needs to be a carboxy group (—COOH), a sulfonic acid group (—SO₃H), a carboxy group in salt form, a sulfonic acid group in salt form, a derivatized carboxy group, or a derivatized sulfonic acid group. R⁶ to R¹² may be identical to each other or different from each other.

In addition, in the general formula (3), R¹³ to R¹⁹ each represent, independently of each other, any of hydrogen (—H), a carboxy group (—COOH), a sulfonic acid group (—SO₃H), a carboxy group in salt form, a sulfonic acid group in salt form, a derivatized carboxy group, and a derivatized sulfonic acid group, provided that at least one of R¹³ to R¹⁹ needs to be a carboxy group (—COOH), a sulfonic acid group (—SO₃H), a carboxy group in salt form, a sulfonic acid group in salt form, a derivatized carboxy group, or a derivatized sulfonic acid group. R¹³ to R¹⁹ may be identical to each other or different from each other.

This is because the compound which should inhibit influenza virus infection and in which each of the general formulae (1) to (3) does not have any of a carboxy group (—COOH), a sulfonic acid group (—SO₃H), a carboxy group in salt form; a sulfonic acid group in salt form, a derivatized carboxy group, and a derivatized sulfonic acid group does not exert the effect of inhibiting influenza virus infection.

Examples of carboxy groups in salt form may include —COONa, (—COO)₂Ca, and —SO₃⁻NH₄, and examples of sulfonic acid groups in salt form may include —SO₃Na, (—SO₃)₂Ca, and —SO₃⁻NH₄⁺.

Furthermore, examples of derivatized carboxy groups may include an esterified form such as —COOCH₃ or —COOC₂H₅, and examples of derivatized sulfonic acid groups may include an esterified form such as —SO₃CH₃ or —SO₃C₂H₅.

In the general formula (1), the total number of a carboxy group, a sulfonic acid group, a carboxy group in salt form, a sulfonic acid group in salt form, a derivatized carboxy group, and a derivatized sulfonic acid group is preferably 1 to 3 and more preferably 11 since a too-big number causes loss of the effect of inhibiting influenza virus infection.

Furthermore, in the general formula (1), it is preferable that R³ be a carboxy group, a sulfonic acid group, a carboxy group in salt form, a sulfonic acid group in salt form, a derivatized carboxy group, or a derivatized sulfonic acid group and R¹, R², R⁴, and R⁵ be hydrogen, since steric hindrance becomes small.

The influenza virus infection inhibitor for fiber processing contains the compound that inhibits influenza virus infection as an active ingredient. The compound that inhibits influenza virus infection is preferably a polymer, and more preferably, a homopolymer of a monomer having at least one of the substituents with the structural formulae represented by the general formulae (1) to (3), or a copolymer that contains not less than 70% by weight of a monomer component having at least one of the substituents with the structural formulae represented by the general formulae (1) to (3).

Examples of the monomer having at least one of the substituents with the structural formulae represented by the general formulae (1) to (3) that constitute the above-described copolymer may include p-styrenesulfonic acid, m-styrenesulfonic acid, o-styrenesulfonic acid, sodium p-styrenesulfonate, sodium m-styrenesulfonate, sodium o-styrenesulfonate, calcium p-styrenesulfonate, calcium m-styrenesulfonate, calcium o-styrenesulfonate, ammonium p-styrenesulfonate, ammonium m-styrenesulfonate, ammonium o-styrenesulfonate, ethyl p-styrenesulfonate, ethyl m-styrenesulfonate, and ethyl o-styrenesulfonate. Sodium styrenesulfonate is preferable. Sodium p-styrenesulfonate is more preferable since the steric hindrance in the reactivity with an influenza virus is small.

In the above-described copolymer, examples of the monomer other than the monomer having at least one of the substituents with the structural formulae represented by the general formulae (1) to (3) may include an alkyl acrylate, an alkyl methacrylate, a vinyl alkyl ether, vinyl acetate, ethylene, propylene, butylene, butadiene, diisobutylene, vinyl chloride, vinylidene chloride, 2-vinylnaphthalene, styrene, acrylonitrile, acrylic acid, sodium acrylate, methacrylic acid, maleic acid, fumaric acid, maleic anhydride, acrylamide, methacrylamide, diacetone acrylamide, vinyltoluene, xylene sulfonic acid, vinylpyridine, vinylsulfonic acid, vinyl alcohol, methyl methacrylate, sodium methacrylate, and hydroxyethyl methacrylate. Maleic acid and styrene are preferable in terms of compatibility with the monomer having at least one of the substituents with the structural formulae represented by the general formulae (1) to (3). Styrene, which imparts water-insolubility, is more preferable in terms of improving washing resistance.

In the above-described copolymer, a low content of the monomer component having at least one of the substituents with the structural formulae represented by the general formulae (1) to (3) may lead to no production of the effect of inhibiting influenza virus infection by the influenza virus infection inhibitor for fiber processing. Alternatively, a low polarity of the monomer component other than the monomer having at least one of the substituents with the structural formulae represented by the general formulae (1) to (3) results in a low polarity of the influenza virus infection inhibitor for fiber processing, and therefore the inhibitor becomes more likely to blend in with a coloring matter such as pigment or dye. For example, when a fiber of a dark color such as black is treated with the inhibitor, a color tone may be changed due to transfer into treatment liquid, color migration to a light color object may occur through rubbing in daily life and result in dirty clothes, or adhesion to clothes may occur and cause dirt that does not come off easily. Therefore, the content of the monomer component is preferably not less than 70% by weight, and more preferably not less than 80% by weight.

A method for producing the above-described compound that inhibits influenza virus infection is not particularly limited. Examples of such methods may include a method by radically polymerizing a monomer having at least one of the substituents with the structural formulae represented by the general formulae (1) to (3) alone, a method by radically polymerizing a monomer having at least one of the substituents with the structural formulae represented by the general formulae (1) to (3) and a monomer copolymerizable therewith, a method by sulfonating a benzene ring of a polymer containing a styrene component or polystyrene, and a method by sulfonating a benzene ring of a polymer containing a styrene component or polystyrene and converting the introduced sulfonic acid group to a sulfonate salt form.

Sulfonation of a benzene ring of a polymer containing a styrene component or polystyrene can be carried out by a known procedure. Examples of such procedures may include a method by using sulfur trioxide, concentrated sulfuric acid, and the like. Examples of methods of producing a sulfonate salt of a compound in which a benzene ring of a polymer containing a styrene component or polystyrene is sulfonated may include a method including sulfonating the benzene ring of the polymer containing a styrene component or polystyrene and neutralizing a dispersion liquid containing the sulfonated compound with an alkaline aqueous solution. Examples of alkaline aqueous solutions may include aqueous solutions containing sodium hydroxide, potassium hydroxide, and the like.

Not all of the sulfuric acid groups in the above-described compound that inhibits influenza virus infection need to be converted to the salt form thereof. However, a low percentage of the sulfuric acid groups converted to the salt form thereof results in a higher acidity of the processing liquid containing the influenza virus infection inhibitor for fiber processing and consequently a fiber may be damaged. Therefore, the above-described percentage is preferably 50% by mole or more, more preferably 70 to 100% by mole, and particularly preferably 85 to 100% by mole.

The percentage of the sulfuric acid groups converted to the salt form thereof in the compound that inhibits influenza virus infection is calculated, for example, by a procedure described below. When a copolymer is produced by copolymerizing a monomer including a styrenesulfonate salt, the total number of moles of the monomers used for copolymerization is calculated and the number of moles of the styrenesulfonate salts is also calculated. Then, the percentage of the number of moles of the styrenesulfonate salts relative to the above-described total number of moles may be calculated.

Furthermore, when the sulfonate salt of the compound that inhibits influenza virus infection is a sodium salt, the amount of sodium sulfonate salts can be calculated by quantifying the amount of sodium by means of atomic absorption spectroscopy, ion chromatography, ICP emission spectrometry, ICP mass spectrometry, and the like, which are capable of analyzing a trace amount of a metal ion. Measurements can be carried out by means of an infrared spectrophotometer by using a polymer including a known amount of sodium sulfonate salts therein as a standard substance, under the conditions described below.

Instrument: a Fourier transform infrared spectrophotometer “IRAffinity-1” by Shimadzu Corporation
Accessory device: diamond prism MIRacle10
Measurement mode: Absorbance
Apodization function: Happ-Genzel
Number of integration: 32
Resolution: 4 cm⁻¹
Wavelength range: 400 to 4000 cm⁻¹
Detection peak: 675 cm⁻¹, 1180 cm⁻¹

A low weight average molecular weight of the compound that inhibits influenza virus infection that constitutes the influenza virus infection inhibitor for fiber processing may lead to a reduced effect of inhibiting influenza virus infection of the influenza virus infection inhibitor for fiber processing. Therefore, the above-described weight average molecular weight is preferably 5,000 or more and more preferably 20,000 or more. However, an excessively high weight average molecular weight may lead to an increased viscosity of the processing liquid containing the influenza virus infection inhibitor for fiber processing and consequently poorer handleability. Thus, the above-described weight average molecular weight is preferably 1,000,000 or less.

In the context of the present invention, the weight average molecular weight and the Z-average molecular weight of a polymer are those determined by size exclusion chromatography using polyethylene oxide as a standard substance. The weight average molecular weight and the Z-average molecular weight of a polymer can be determined, for example, under the conditions described below.

Column: (Shodex GF-7M HQ 7.6 mm I.D.×30 cm, manufactured by Showa Denko K.K., one column)
Eluent: (0.05 M sodium sulfate aqueous solution:THF=7:3)
Flow rate: 0.6 ml/min

### Temperature: 40° C.

### Detection: UV (210 nm)

Standard sodium polystyrene sulfonate: sodium polystyrene sulfonate manufactured by Scientific Polymer Products, Inc. was used

When the compound that inhibits influenza virus infection that constitutes the influenza virus infection inhibitor for fiber processing is a block copolymer, the degree of polymerization of a block moiety derived from a monomer having at least one of the substituents with the structural formulae represented by the general formulae (1) to (3) is preferably 5 to 6,000. This is because, a low degree of polymerization may lead to no production of the effect of inhibiting influenza virus infection of the influenza virus infection inhibitor for fiber processing, while an excessively high degree of polymerization may lead to an increased viscosity of the processing liquid containing the influenza virus infection inhibitor for fiber processing and consequently poorer handleability.

When the influenza virus infection inhibitor for fiber processing is water-insoluble, washing resistance of the fiber treated with the influenza virus infection inhibitor for fiber processing is improved and the effect of inhibiting influenza virus infection can be produced stably for a long period.

In this context, “water-insoluble” means that the amount by gram of a substance dissolvable in 100 g of water at 20° C. and at pH 5 to 9 (referred to as “solubility” hereinafter) is 1 or less. When this value is more than 1, the substance is referred to as “water-soluble.”

A method for making the influenza virus infection inhibitor for fiber processing water-insoluble is not particularly limited, Examples of such methods may include (1) a method by crosslinking the compound that inhibits influenza virus infection with a curing agent, and (2) a method by anchoring the compound that inhibits influenza virus infection to a support.

Alternatively, a water-insoluble copolymer can be obtained as follows. Thus, in a copolymer that constitutes the influenza virus infection inhibitor for fiber processing, a highly hydrophobic monomer is used as a monomer that is copolymerized with the monomer having at least one of the substituents with the structural formulae represented by the general formulae (1) to (3) to increase the content of the highly hydrophobic monomer component in the copolymer. Examples of such highly hydrophobic monomers may include styrene and vinylphenol.

The above-described curing agent is not particularly limited as long as it can crosslink the compound that inhibits influenza virus infection. Examples of the curing agents may include an epoxy compound, an amine compound, a compound synthesized from an amine compound, such as a polyamino amide compound, a tertiary amine compound, an imidazole compound, a hydrazide compound, a melamine compound, an acid anhydride, a phenol compound, a thermally latent cationic polymerization catalyst, a photo-latent cationic polymerization initiator, dicyanamide and derivatives thereof, and divinylbenzene. These curing agents may be used alone or in a combination of two or more thereof.

The epoxy compound is not particularly limited. Examples of the epoxy compounds may include a water-insoluble epoxy compound such as a bisphenol type epoxy resin and a novolac type epoxy resin, and a water-soluble epoxy compound such as a glycerol-modified epoxy resin and a polyoxyalkylene-modified epoxy resin. A water-soluble epoxy compound is preferable because of good reactivity thereof. Preferably, the water-insoluble epoxy compound is used after being dispersed in water using a general-purpose emulsifier.

The amine compound is not particularly limited. Examples of the amine compounds may include an aliphatic amine and derivatives thereof, such as ethylenediamine, diethylenetriamine, triethylenetetramine, tetraethylenepentamine, polyoxypropylenediamine, and polyoxypropylenetriamine; an alicyclic amine and derivatives thereof, such as menthene diamine, isophorone diamine, bis(4-amino-3-methylcyclohexyl)methane, diamino dicyclohexyl methane, bis(aminomethyl)cyclohexane, N-aminoethyl piperazine, and 3,9-bis(3-aminopropyl)2,4,8,10-tetraoxaspiro(5,5)undecane; and an aromatic amine and derivatives thereof, such as m-xylenediamine, α-(m-aminophenyl)ethylamine, α-(p-aminophenyl)ethylamine, m-phenylenediamine, diaminodiphenylmethane, diaminodiphenylsulfone, and α,α-bis(4-aminophenyl)-p-diisopropylbenzene.

Furthermore, the compound synthesized from an amine compound is not particularly limited. Examples of such compounds may include a polyamino amide compound and derivatives thereof synthesized from the above-described amine compound and a carboxylic acid compound such as succinic acid, adipic acid, azelaic acid, sebacic acid, dodecadioic acid, isophthalic acid, terephthalic acid, dihydro isophthalic acid, tetrahydro isophthalic acid, or hexahydro isophthalic acid; a polyamino imide compound and derivatives thereof synthesized from the above-described amine compound and a maleimide compound such as diaminodiphenylmethane bismaleimide; a ketimine compound and derivatives thereof synthesized from the above-described amine compound and a ketone compound; and a polyamino compound and derivatives thereof synthesized from the above-described amine compound and a compound such as an epoxy compound, urea, thiourea, an aldehyde compound, a phenolic compound, or an acrylic compound.

Furthermore, the above-described tertiary amine compound is not particularly limited. Examples of the tertiary amine compounds may include N,N-dimethylpiperazine, pyridine, picoline, benzyldimethylamine, 2-(dimethylaminomethyl)phenol, 2,4,6-tris(dimethylaminomethyl)phenol, 1,8-diazabiscyclo(5,4,0)undecene-1, and derivatives thereof.

The above-described imidazole compound is not particularly limited. Examples of the imidazole compounds may include 2-methylimidazole, 2-ethyl-4-methylimidazole, 2-undecylimidazole, 2-heptadecylimidazole, 2-phenylimidazole, and derivatives thereof.

Furthermore, the above-described hydrazide compound is not particularly limited. Examples of the hydrazide compounds may include 1,3-bis(hydrazinocarboethyl)-5-isopropylhydantoin, 7,11-octadecadiene-1,18-dicarbohydrazide, eicosane diacid dihydrazide, adipic acid dihydrazide, and derivatives thereof.

Furthermore, the above-described melamine compound is not particularly limited. Examples of the melamine compounds may include 2,4-diamino-6-vinyl-1,3,5-triazine and derivatives thereof.

The above-described acid anhydride is not particularly limited. Examples of the acid anhydrides may include phthalic anhydride, trimellitic anhydride, pyromellitic anhydride, benzophenone tetracarboxylic anhydride, ethylene glycol bisanhydrotrimellitate, glycerol trisanhydrotrimellitate, methyl tetrahydrophthalic anhydride, tetrahydrophthalic anhydride, nadic anhydride, methyl nadic anhydride, trialkyl tetrahydro phthalic anhydride, hexahydro phthalic anhydride, methyl hexahydrophthalic anhydride, 5-(2,5-dioxotetrahydrofuryl)-3-methyl-3-cyclohexene-1,2-dicarboxylic anhydride, maleic anhydride adduct of trialkyl tetrahydrophthalic anhydride, dodecenylsuccinic anhydride, polyazelaic anhydride, polydodecanedioic anhydride, chlorendic anhydride, and derivatives thereof.

Furthermore, the above-described phenolic compound is not particularly limited. Examples of the phenolic compounds may include phenol novolac, o-cresol novolac, p-cresol novolac, t-butyl phenol novolac, dicyclopentadiene cresol, and derivatives thereof.

Furthermore, the above-described thermally latent cationic polymerization catalyst is not particularly limited. Examples of such catalysts may include an ionic thermally latent cationic polymerization catalyst such as a benzyl sulfonium salt, a benzyl ammonium salt, a benzyl pyridinium salt, and a benzyl phosphonium salt for which antimony hexafluoride, phosphorus hexafluoride, boron tetrafluoride, or the like serves as a counter anion; and a nonionic thermally latent cationic polymerization catalyst such as N-benzylphthalimide and an aromatic sulfonate ester.

The above-described photo-latent cationic polymerization initiator is not particularly limited. Examples of such initiators may include an ionic photo-latent cationic polymerization initiator such as onium salts (an aromatic diazonium salt, an aromatic halonium salt, an aromatic sulfonium salt, and the like) for which antimony hexafluoride, phosphorus hexafluoride, boron tetrafluoride, or the like serves as a counter anion, or organometallic complexes (a complex of iron and allene, a titanocene complex, a complex of arylsilanol and aluminum, and the like); and a nonionic photo-latent cationic polymerization initiator such as a nitrobenzyl ester, a sulfonic acid derivative, a phosphate ester, a phenolsulfonate ester, diazonaphthoquinone, and N-hydroxyimidosulfonate.

The support for anchoring the compound that inhibits influenza virus infection is not particularly limited. Examples of such supports may include an inorganic support such as talc, bentonite, clay, kaolin, diatomaceous-earth, silica, vermiculite, and perlite; and an organic macromolecule support such as a polyolefin resin (polyethylene, polypropylene, and the like), a polyurethane resin, a melamine resin, and an alkyd resin.

The form of the organic macromolecule support is not particularly limited. Examples of the forms may include a microparticle shape, a fiber shape, a sheet shape, a film shape, and a foam. When the compound that inhibits influenza virus infection is supported by a foam, the compound that inhibits influenza virus infection may be supported before foaming an expandable shaped body that is raw fabric of the foam, or the compound that inhibits influenza virus infection may be supported after foaming the expandable shaped body.

Examples of methods for anchoring the compound that inhibits influenza virus infection to a support may include, but are not particularly limited to, a method by allowing the compound that inhibits influenza virus infection to be adsorbed on the support and a method of anchoring the compound that inhibits influenza virus infection to the support by chemical binding such as grafting or binding with a binder. It is preferable that the compound that inhibits influenza virus infection be bound to the molecular terminal of an organic macromolecule support.

A pharmaceutical auxiliary such as a dispersant, an emulsifier, an antioxidant, an ultraviolet absorber, or an anti-migration agent may be included in the influenza virus infection inhibitor for fiber processing of the present invention to the extent that the auxiliary does not impair the efficacy of the effect of inhibiting influenza virus infection. Furthermore, a miticide, a bactericide, an antimold, a deodorant, and the like may also be contained in the inhibitor.

The anti-migration agent is not particularly limited. Examples of the anti-migration agents may include salts such as calcium chloride, a water-soluble cationic compound, polyvinyl pyrrolidone, polyvinyl pyridine betaine, and a polyamine N-oxide polymer.

A procedure for using the above-described influenza virus infection inhibitor for fiber processing will be now described. General methods of use can be used for the above-described influenza virus infection inhibitor for fiber processing, for example, the inhibitor can be used in a spray form, in an aerosol form, in a smoke form, in the heat transpiration, or by being mixed into a matrix.

A spray form of the influenza virus infection inhibitor for fiber processing can be produced as follows: the above-described influenza virus infection inhibitor for fiber processing is dissolved or dispersed in a solvent to obtain a solution of the influenza virus infection inhibitor for fiber processing; a water soluble chemical, an oil, an emulsion, a suspension, and the like are mixed into the obtained solution of the influenza virus infection inhibitor for fiber processing. Herein, a method using a spray form refers to a method of use in which pressure is applied to the solution of the influenza virus infection inhibitor for fiber processing at atmospheric pressure and the influenza virus infection inhibitor for fiber processing is nebulized in a mist form.

Examples of the above-described solvents may include water (preferably, ion exchanged water), alcohols (for example, methyl alcohol, ethyl alcohol, and propyl alcohol), hydrocarbons (for example, toluene, xylene, methylnaphthalene, kerosene, and cyclohexane), ethers (for example, diethyl ether, tetrahydrofuran, and dioxane), ketones (for example, acetone and methyl ethyl ketone), and amides (for example, N,N-dimethylformamide).

Then, an aerosol form of the influenza virus infection inhibitor for fiber processing can be produced by adding a solid carrier (for example, talc, bentonite, clay, kaolin, diatomaceous earth, silica, vermiculite, or perlite) to the above-described spray form of the influenza virus infection inhibitor for fiber processing.

In this context, a method using an aerosol form refers to a method of use in which the solution of the influenza virus infection inhibitor for fiber processing ie sealed in a container together with a propellant with the propellant being compressed, and the influenza virus infection inhibitor for fiber processing is nebulized in a mist form by the pressure of the propellant. Examples of the propellants may include nitrogen, carbonic acid gas, dimethyl ether, and LPG.

Then, a smoke form of the influenza virus infection inhibitor for fiber processing can be produced by adding an oxygen supplying agent (for example, potassium perchlorate, potassium nitrate, and potassium chlorate), a combustion agent (for example, saccharides and starch), a heat generation-regulating agent (for example, guanidine nitrate, nitroguanidine, and guanylurea phosphate), an aid for breaking down an oxygen supplying agent (for example, potassium chloride, copper oxide, chromium oxide, iron oxide, and activated charcoal), and the like to the above-described spray form of the influenza virus infection inhibitor for fiber processing. A method using a smoke form refers to a method of use in which the influenza virus infection inhibitor for fiber processing is micronized into a smoke form and dispersed.

Furthermore, the matrix that the influenza virus infection inhibitor for fiber processing is mixed into is not particularly limited as long as the matrix does not denature the influenza virus infection inhibitor for fiber processing. Examples of the matrices may include polysaccharides and salts thereof, dextrin, gelatin, a higher alcohol, oils and fats, a higher fatty acid such as stearic acid, paraffins, liquid paraffins, white petrolatum, hydrocarbon gel ointment, polyethylene glycol, polyvinyl alcohol, sodium polyacrylate, and various coatings.

The above-described influenza virus infection inhibitor for fiber processing can be provided on a fiber product by nebulization, dispersion, application, or fixing depending on each method of use, wherein the fiber product is the one in which a virus exists or a virus is likely to exist in the future and it is desirable to prevent virus infection in a human caused by the virus existing in such fiber products (hereinafter, referred to as “an influenza virus fiber product”). Thus, the effect of inhibiting influenza virus infection can be imparted to the fiber product to obtain a fiber product that inhibits influenza virus infection and virus infection in a human caused by the virus existing in the influenza virus fiber product can be mostly prevented. The above-described influenza virus infection inhibitor for fiber processing may be used alone or in a combination of two or more thereof.

The fiber product that inhibits influenza virus infection contains the influenza virus infection inhibitor for fiber processing that exerts an excellent effect of inhibiting influenza virus infection. Therefore, when an influenza virus comes into contact with the fiber product that inhibits influenza virus infection, the fiber product eliminates or reduces the infectivity of the influenza virus to a cell, or disables the influenza virus from growing in a cell even if the influenza virus infects the cell. In this manner, the fiber product can suppress the infectivity to a human effectively.

The influenza virus infection inhibitor for fiber processing has an excellent stability when it is in the form of a suspension prepared by adding a suspending agent to the above-described solution of the influenza virus infection inhibitor for fiber processing. Therefore, it is preferable to prepare a suspension of the influenza virus infection inhibitor for fiber processing and nebulize the suspension as a spray form to the influenza virus fiber product.

The below-mentioned method for binding chemically or fixing physically the influenza virus infection inhibitor to a fiber can be used as a method for fixing chemically or physically the influenza virus infection inhibitor for fiber processing to the influenza virus fiber product.

Examples of the above-described fiber products may include ones that become a hotbed of viruses in living space. Examples of the fiber products may include a fabric (for example, a woven fabric, a knitted fabric, a nonwoven fabric, and the like), a carpet, a futon, a bed sheet, a curtain, a towel, clothing, and a stuffed toy.

The influenza virus infection inhibitor for fiber processing of the present invention is particularly excellent in rubbing fastness. Therefore, even if a fiber product treated with the influenza virus infection inhibitor for fiber processing is colored and the fiber product rubs against other objects, the color of the fiber product does not migrate to the other objects or the degree of coloring of the fiber product is not reduced.

When the lightness value L* of the fiber product that inhibits influenza virus infection is 80 or less and the fiber product is colored a dark color, the effect of rubbing fastness of the influenza virus infection inhibitor for fiber processing is more likely to be exerted. The lightness value L* of the fiber product that inhibits influenza virus infection is preferably 80 or less, more preferably 60 or less, and particularly preferably 30 or less. In the present invention, the lightness value L* of the fiber product that inhibits influenza virus infection is a value measured in accordance with JIS Z8729. The closer to 100 the lightness value L* is, the closer the color is to white, while the closer to 0 the L* is, the darker the color is. The lightness value L* of the fiber product that inhibits influenza virus infection can be measured by using, for example, a color and color difference meter commercially available from Konica Minolta, Inc. under the trade name “CR200.”

When the fiber constituting the influenza virus fiber product is a polyester resin fiber, which is difficult to color and is prone to lose color, the effect of rubbing fastness of the above-described influenza virus infection inhibitor for fiber processing is more likely to be exerted. The polyester resin is not particularly limited and examples thereof may include polyethylene terephthalate and polynaphthalene terephthalate.

Furthermore, since the influenza virus infection inhibitor for fiber processing of the present invention hardly causes unexpected coloring or discoloration in a daily living environment, the inhibitor can be used favorably even for use where loss of color and discoloration caused by light becomes a problem.

A small amount of the influenza virus infection inhibitor for fiber processing of the present invention used for the influenza virus fiber product may lead to no production of the effect of inhibiting influenza virus infection by the influenza virus infection inhibitor for fiber processing. On the other hand, a large amount of the inhibitor used may lead to a damaged influenza virus fiber product. Thus, the amount of usage is preferably 0.001 to 100 parts by weight, more preferably 0.01 to 50 parts by weight, especially preferably 0.02 to 30 parts by weight, and most preferably 0.02 to 20 parts by weight relative to 100 parts by weight of the influenza virus fiber product.

In the present invention, a method for extracting the influenza virus infection inhibitor from a fiber product that inhibits influenza virus infection is, for example, a method in which the influenza virus infection inhibitor can be extracted in an extract by immersing the fiber product that inhibits influenza virus infection in a liquid for extraction at 35 to 40° C. for 24 hours. Pure water can be used as the liquid for extraction.

According to the above-described procedure for using the influenza virus infection inhibitor for fiber processing, influenza virus infection in a human caused by the influenza virus that exists or is likely to exist in the future in an influenza virus fiber product is mostly inhibited by providing the influenza virus infection inhibitor for fiber processing onto the influenza virus fiber product as needed.

The effect of inhibiting influenza virus infection may be imparted to a fiber itself by treating the fiber with the above-described influenza virus infection inhibitor for fiber processing and thereby obtaining a fiber that inhibits influenza virus infection. The effect of inhibiting influenza virus infection can be imparted to a fiber product in advance by producing the above-described fiber product by using this fiber that inhibits influenza virus infection.

Examples of methods for treating a fiber with the influenza virus infection inhibitor for fiber processing may include a method for binding chemically or fixing physically the influenza virus infection inhibitor for fiber processing to the fiber and a method for making the fiber contain the influenza virus infection inhibitor for fiber processing. The fiber is not particularly limited as long as it is possible to make the fiber contain the influenza virus infection inhibitor for fiber processing. Examples of the fibers may include a synthetic fiber such as a polyester fiber, a nylon fiber, an acrylic fiber, and a polyolefin fiber; a semi-synthetic fiber such as an acetate fiber; a regenerated fiber such as cupra and rayon; a natural fiber such as cotton, hemp, wool, and silk; and a conjugated fiber of these various fibers and mixed cotton.

Procedures for binding the above-described influenza virus infection inhibitor for fiber processing to a fiber chemically include a method for binding the influenza virus infection inhibitor for fiber processing to a fiber chemically by a grafting reaction. The grafting reaction is not particularly limited. Examples of the grafting reactions may include (1) a graft polymerization method in which a polymerization starting point is created on a trunk polymer that constitutes a fiber and an influenza virus infection inhibitor for fiber processing is polymerized to the trunk polymer as a branch polymer, and (2) a macromolecule reaction method in which the influenza virus infection inhibitor for fiber processing is bound to a fiber chemically by a macromolecule reaction.

Examples of the graft polymerization methods may include (1) a method that uses a chain transfer reaction onto a fiber to generate a radical and allows polymerization to be performed, (2) a method in which an oxidation-reduction system (redox system) is formed by reacting a ceric salt, a silver sulfate salt, or the like with a reducing substance such as an alcohol, a thiol, or an amine, thereby free radical is generated on a fiber, and polymerization is performed, (3) a method in which a fiber is irradiated with a γ ray or an accelerated electron beam in a situation where the fiber is made to coexist with a monomer serving as a raw material of the compound that inhibits influenza virus infection, (4) a method in which only a fiber is irradiated with a γ ray or an accelerated electron beam and subsequently a monomer serving as a raw material of the compound that inhibits influenza virus infection is added, and thereby polymerization is performed, (5) a method in which a macromolecule constituting a fiber is oxidized to introduce a peroxy group or a diazo group is introduced from an amino group on a side chain, and polymerization is performed by using these introduced groups as a polymerization starting point, and (6) a method that uses a polymerization initiation reaction of epoxy, a lactam, a polar vinyl monomer, or the like initiated by an active group on a side chain such as a hydroxy group, an amino group, or a carboxyl group.

Furthermore, graft polymerization methods are listed specifically: a) a method in which a free radical is generated by grinding cellulose in a monomer serving as a raw material of the compound that inhibits influenza virus infection and thereby graft polymerization is performed; b) a method in which graft polymerization is performed by using a monomer serving as a raw material of the compound that inhibits influenza virus infection and a cellulose derivative (for example, mercaptoethyl cellulose) as a fiber, the cellulose derivative having a group likely to undergo chain transfer; c) a method in which graft polymerization is performed by a method of oxidizing ozone or a peroxide to generate a radical; d) a method in which a double bond of an allyl ether, a vinyl ether, a methacrylate ester, or the like is introduced into the side chain of cellulose and graft polymerization is performed; e) a method in which a fiber is irradiated with an ultraviolet ray, with sodium anthraquinone-2,7-disulfonate and the like being used as a photosensitizer, and graft polymerization is performed; and f) a method in which a fiber is wound around a cathode, a monomer serving as a raw material of the compound that inhibits influenza virus infection is added to dilute sulfuric acid, and an external voltage is applied, whereby graft polymerization is performed electrochemically.

Considering that the graft polymerization is performed onto a fiber, the following methods are preferable: g) a method in which a fiber coated with glycidyl methacrylate (GMA) and benzoyl peroxide is heated in a solution of a monomer serving as a raw material of the compound that inhibits influenza virus infection, whereby graft polymerization is performed; and h) a method in which a monomer serving as a raw material of the compound that inhibits influenza virus infection is added to a dispersion liquid obtained by dispersing benzoyl peroxide, a surfactant (a nonionic surfactant or an anionic surfactant), and monochlorobenzene in water, a fiber such as a polyester resin fiber is immersed therein and heated, whereby graft polymerization is performed.

General methods can be used as the above-described macromolecule reaction method. Examples of the macromolecule reaction methods may include (1) a chain transfer reaction to, an oxidation reaction of, or a substitution reaction of C—H, (2) an addition reaction to or an oxidation reaction of a double bond, (3) esterification, etherification, or acetalization of a hydroxy group, a substitution reaction of, an addition reaction to, or a hydrolytic reaction of an ester group or an amide group, or a substitution reaction of or an elimination reaction of a halogen group, and (4) a substitution reaction (halogenation, nitration, sulfonation, or chloromethylation) of an aromatic ring.

Next, a method for fixing the influenza virus infection inhibitor for fiber processing to a fiber physically will be described. Examples of the methods for fixing the influenza virus infection inhibitor for fiber processing to a fiber physically may include: (1) a method in which the influenza virus infection inhibitor for fiber processing is dissolved or dispersed in a solvent to prepare a solution of the influenza virus infection inhibitor for fiber processing, and a fiber is impregnated with the solution of the influenza virus infection inhibitor for fiber processing to impregnate the fiber with the solution of the influenza virus infection inhibitor for fiber processing; (2) a method in which the above-described solution of the influenza virus infection inhibitor for fiber processing is applied onto the surface of a fiber; (3) a method in which a fiber is immersed in a binder prepared by dissolving or dispersing the above-described influenza virus infection inhibitor for fiber processing, and the influenza virus infection inhibitor for fiber processing is fixed to the fiber by the binder; and (4) a method in which the above-described binder prepared by dissolving or dispersing the influenza virus infection inhibitor for fiber processing is applied onto the surface of a fiber and the influenza virus infection inhibitor for fiber processing is fixed to the fiber by the binder. In the above-described methods (1) and (2), a binder described below may be included in the solution of the influenza virus infection inhibitor for fiber processing.

The above-described solvent is not particularly limited. Examples of the solvents may include water; alcohols such as methyl alcohol, ethyl alcohol, and propyl alcohol; hydrocarbons such as toluene, xylene, methylnaphthalene, kerosene, and cyclohexane; ethers such as diethyl ether, tetrahydrofuran, and dioxane; ketones such as acetone and methyl ethyl ketone; and amides such as N,N-dimethylformamide.

The above-described binder is not particularly limited as long as the binder can fix the influenza virus infection inhibitor for fiber processing on the surface of a fiber. Examples of binders composed of a synthetic resin may include a urethane resin such as a one-component urethane resin and a two-component urethane resin, an acrylic resin, an urethane acrylate resin, a polyester resin, an unsaturated polyester resin, an alkyd resin, a vinyl acetate resin, a vinyl chloride resin, an epoxy resin, and an epoxy acrylate resin. A urethane resin is preferable.

Hereinabove, the procedure for treating a fiber with the influenza virus infection inhibitor for fiber processing by binding chemically of fixing physically the influenza virus infection inhibitor for fiber processing to a fiber that was produced separately has been described. However, a fiber raw material including the influenza virus infection inhibitor for fiber processing may be spun to produce a fiber, or spinning is performed with a spinning dope that is prepared by including the influenza virus infection inhibitor for fiber processing in a fiber raw material, thereby producing a fiber.

The procedure for producing the fiber raw material including the influenza virus infection inhibitor for fiber processing is not particularly limited. Examples of such procedures may include a method for producing the fiber raw material by copolymerizing a monomer having at least one of the substituents with the structural formulas represented by the general formulae (1) to (3) with a monomer serving as a general fiber raw material.

The method for producing a fiber by performing spinning with a spinning dope that is prepared by including the influenza virus infection inhibitor for fiber processing in a fiber raw material is not particularly limited. For example, a fiber containing the influenza virus infection inhibitor for fiber processing can be produced by dissolving or suspending the influenza virus infection inhibitor for fiber processing in an aqueous solution of sodium hydroxide, if necessary, then adding the solution or suspension to a cellulose solution to prepare a spinning dope, and extruding the spinning dope into a regeneration bath to coagulate and regenerate the dope in a fiber shape.

Examples of the cellulose solutions may include viscose and a solution of cellulose dissolved in a cuprammonium liquid. For example, viscose is produced by the following procedure. Dissolving pulp for rayon (containing 92 to 93% by weight of α-cellulose) produced from a conifer or broad-leaved tree timber by a sulfite process or a sulfate process is used as a cellulose raw material. This cellulose raw material is reacted with an aqueous solution of sodium hydroxide to produce alkali cellulose. Then, the alkali cellulose is aged by allowing it to stand at 25 to 35° C. for 24 to 72 hours and thereby the degree of polymerization of the cellulose is reduced so that the cellulose has a viscosity suitable for spinning. After that, carbon disulfide is added to the alkali cellulose to form sodium cellulose xanthate, by which viscose can be produced.

Furthermore, the solution of cellulose dissolved in a cuprammonium liquid is produced, for example, by the following procedure. Purified cotton linters or purified wood pulp is used as a cellulose raw material. (Particularly, linters containing not less than 99% by weight of α-cellulose are preferable. Separately, a copper sulfate solution is reacted with ammonia water at room temperature to generate basic copper sulfate, and then, sodium hydroxide is added thereto to prepare a cuprammonium liquid. The solution of cellulose dissolved in a cuprammonium liquid can be prepared by adding a cellulose raw material to this cuprammonium liquid.

A small amount of the influenza virus infection inhibitor for fiber processing to be added to the cellulose solution may lead to a reduced effect of inhibiting influenza virus infection of the influenza virus infection inhibitor for fiber processing. A large amount of the above-described inhibitor may lead to reduced strength of a fiber and cause a problem from a practical standpoint. Therefore, the amount of the above-described inhibitor is preferably 0.1 to 5.0 parts by weight, and more preferably 1 to 20 parts by weight relative to 100 parts by weight of the cellulose.

A fiber containing the influenza virus infection inhibitor for fiber processing can be obtained by extruding the spinning dope obtained as described above into a regeneration bath to coagulate and regenerate the dope into a fiber shape. Specifically, when viscose is used as the cellulose solution, a fiber containing the influenza virus infection inhibitor for fiber processing can be obtained by ripening viscose in a spinning dope by a known procedure, then feeding the spinning dope to a spinning machine, and extruding the dope into a regeneration bath through a spinneret to coagulate and regenerate the dope into a fiber shape. In this context, the regeneration bath generally contains 8 to 12% by weight of sulfuric acid, 15 to 40% by weight of sodium sulfate, and 0 to 2% by weight of zinc sulfate.

Furthermore, when the solution of cellulose dissolved in a cuprammonium liquid is used as the cellulose solution, the spinning dope is diluted with ammonia water if necessary to adjust the cellulose concentration, the copper concentration, the ammonia concentration, and the like, and thereby to adjust the viscosity, then filtrated with a wire mesh, and subsequently deaerated. Then, the spinning dope may be subjected to spinning by a stretch spinning method to obtain a fiber containing the influenza virus infection inhibitor for fiber processing. Specifically, the fiber containing the influenza virus infection inhibitor for fiber processing can be obtained as follows: the spinning dope is coagulated by extruding it into warm water at 30 to 45° C. through a spinneret having a relatively large 0.5 to 1.0 mm hole. The thread thus obtained is passed through a funnel and the thread is stretched to several hundred times its original length by using a stream of water while passing through the funnel. Subsequently, the thread is passed through a sulfuric acid bath to remove copper and regenerate cellulose at the same time.

When a fiber product is formed by using a fiber treated with the influenza virus infection inhibitor for fiber processing as described above, the fiber product can serve as a fiber product that inhibits influenza virus infection and the effect of inhibiting influenza virus infection can be imparted to the fiber product beforehand.

When the fiber product that inhibits influenza virus infection is a fabric, a low content of the influenza virus infection inhibitor for fiber processing in the fiber product that inhibits influenza virus infection may lead to no production of the desired effect of inhibiting influenza virus infection of the fiber product that inhibits influenza virus infection. A high content of the inhibitor may result in reduced texture of the fiber product that inhibits influenza virus infection. Therefore, the content is preferably 0.1 to 5 g/m², and more preferably 0.2 to 1 g/m².

Furthermore, the fiber product that inhibits influenza virus infection contains the influenza virus infection inhibitor for fiber processing that exerts an excellent effect of inhibiting influenza virus infection. Therefore, when an influenza virus comes into contact with the fiber product that inhibits influenza virus infection, the fiber product eliminates or reduces the infectivity of the influenza virus to a cell, or disables the influenza virus from growing in a cell even if the influenza virus infects the cell. In this manner, the fiber product can suppress the infectivity to a human effectively.

The influenza virus infection inhibitor for fiber processing is excellent in rubbing fastness, also in the fiber product that inhibits influenza virus infection obtained by using the fiber that inhibits influenza virus infection as described above. Therefore, even if the fiber product that inhibits influenza virus infection is colored and the fiber product that inhibits influenza virus infection rubs against other objects, the color of the fiber product that inhibits influenza virus infection does not migrate to the other objects or the degree of coloring of the fiber product that inhibits influenza virus infection is not reduced.

When the lightness value L* of the fiber product that inhibits influenza virus infection obtained by using the fiber that inhibits influenza virus infection is 80 or less and the fiber product is colored a dark color, the effect of rubbing fastness of the influenza virus infection inhibitor for fiber processing is more likely to be exerted. The lightness value L* of the fiber product that inhibits influenza virus infection is preferably 80 or less, more preferably 60 or less, and particularly preferably 30 or less.

When the fiber that inhibits influenza virus infection is a polyester resin fiber, which is difficult to color and is prone to lose color, the effect of rubbing fastness of the above-described influenza virus infection inhibitor for fiber processing is more likely to be exerted. The polyester resin fiber is not particularly limited, and examples thereof may include a polyethylene terephthalate fiber and a polynaphthalene terephthalate fiber.

### Advantageous Effects of Invention

The influenza virus infection inhibitor for fiber processing of the present invention can mostly inhibit an influenza virus from infecting a human and thereby prevent onset of a symptom or, if any symptom occurs, aim at alleviation of the symptom, since the inventive inhibitor has the above-described constitution. Additionally, even if a fiber product treated with the influenza virus infection inhibitor for fiber processing is colored and the fiber product rubs against other objects, the color of the fiber product does not migrate to the other objects or the degree of coloring of the fiber product is not reduced, since the inhibitor has an excellent rubbing fastness.

Furthermore, the influenza virus infection inhibitor for fiber processing of the present invention is less likely to cause unexpected discoloration or discoloration under usual conditions of use and therefore cap be used favorably for various daily necessities.

### DESCRIPTION OF EMBODIMENTS

Hereinbelow, embodiments of the present invention will be described in more detail by way of examples. However, the present invention is not limited only to these examples.

### Example 1

1.5 parts by weight of an aqueous solution of an infection inhibitor that includes a polymer consisting only of sodium p-styrenesulfonate (a sodium p-styrenesulfonate homopolymer) as an influenza virus infection inhibitor for fiber processing (manufactured by Tosoh Organic Chemical Co., Ltd. under the trade name of “PS-100,” the content of the sodium p-styrenesulfonate homopolymer: 20% by weight, the weight average molecular weight (Mw): 529,000, and the Z-average molecular weight (Mz): 758,000) and 92.5 parts by weight of ion exchanged water were mixed uniformly to obtain a treatment solution. A tricot fabric including 100% by weight of 40 denier and 32 gauge polyester resin fibers was immersed entirely in the treatment solution for 2 minutes. The immersed tricot-fabric was squeezed with a manually operated mangle and was dried at 120° C. for 20 minutes. In this manner, a fiber product that inhibits influenza virus infection in which the sodium p-styrenesulfonate homopolymer was fixed physically on the tricot fabric as the influenza infection inhibitor was produced. The fiber product that inhibits influenza virus infection contained 1 g/m² of the sodium p-styrenesulfonate homopolymer. The lightness value L* of the fiber product that inhibits influenza virus infection was 23.4.

### Example 2

A fiber product that inhibits influenza virus infection was produced in the same manner as Example 1, except that an aqueous solution of an infection inhibitor that includes a polymer consisting only of sodium p-styrenesulfonate (a sodium p-styrenesulfonate homopolymer) as an influenza virus infection inhibitor for fiber processing (manufactured by Tosoh Organic Chemical Co., Ltd. under the trade name of “PS-5,” the content of the sodium p-styrenesulfonate homopolymer: 20% by weight, the weight average molecular weight (Mw): 107,000, and the Z-average molecular weight (Mz): 249,000) was used as an aqueous solution of an infection inhibitor. The fiber product that inhibits influenza virus infection contained 1 g/m² of the sodium p-styrenesulfonate homopolymer. The lightness value L* of the fiber product that inhibits influenza virus infection was 23.6.

### Example 3

1.5 parts by weight of sulfonated polystyrene (manufactured by AkzoNobel under the trade name of “VERSA-TL502,” the percentage of sulfonated benzene rings in styrene units: 96% by weight, the weight average molecular weight (Mw): 606,000, and the solubility: 30 or more) as an influenza virus infection inhibitor for fiber processing and 98.5 parts by weight of ion exchanged water were mixed uniformly to obtain a treatment solution. A tricot fabric including 100% by weight of 40 denier and 32 gauge polyester resin fibers was immersed entirely in the treatment solution for 2 minutes. The immersed fabric was squeezed with a manually operated mangle and was dried at 120° C. for 20 minutes. In this manner, a fiber product that inhibits influenza virus infection in which the sulfonated polystyrene was fixed physically on the tricot fabric as the influenza infection inhibitor was produced. The fiber product that inhibits influenza virus infection contained 1 g/m² of the sulfonated polystyrene. The lightness value L* of the fiber product that inhibits influenza virus infection was 23.5.

### Example 4

A fiber product that inhibits influenza virus infection was produced in the same manner as Example 3, except that sulfonated polystyrene (manufactured by AkzoNobel under the trade name of “VERSA-TL70,” the percentage of sulfonated benzene rings in styrene units: 96% by weight, the weight average molecular weight (Mw): 76,000, and the solubility: 30 or more) was used as an influenza virus infection inhibitor. The fiber product that inhibits influenza virus infection contained 1 g/m² of the sulfonated polystyrene. The lightness value L* of the fiber product that inhibits influenza virus infection was 23.4.

### Example 5

91 parts by weight pf sodium p-styrenesulfonate (manufactured by Tosoh Corporation under the trade name of “SPINOMAR NaSS,” the purity: 88.2% by weight), 200 parts by weight of ion exchanged water, 18 parts by weight of styrene monomers, and 300 parts by weight of ethanol (manufactured by Wako Pure Chemical Industries, Ltd. under the trade name of “86% ethanol-ME, denaturated”) were added into a 2 liter separable flask equipped with a stirrer, a condenser, and a thermometer. After the gas in the separable flask was replaced by nitrogen gas while stirring, the mixed liquid in the separable flask was heated and maintained at 78° C.

A polymerization initiator solution prepared by dissolving 1.5 parts by weight of potassium peroxodisulfate (manufactured by Wako Pure Chemical Industries, Ltd.) in 100 parts by weight of ion exchanged water was added into the separable flask over 15 minutes. Then, the styrene and the sodium p-styrenesulfonate were allowed to polymerize over a 5 hour period.

After that, the ion exchanged water in the separable flask was removed with an evaporator, and subsequently, the resulting precipitate was centrifuged while washing it with ion exchanged water to obtain a sodium p-styrenesulfonate-styrene random copolymer.

The obtained sodium p-styrenesulfonate-styrene random copolymer contained 70% by weight of the sodium p-styrenesulfonate component and 30% by weight of the styrene component. The weight average molecular weight (Mw), of the sodium p-styrenesulfonate-styrene random copolymer was 110,000.

A fiber product that inhibits influenza virus infection was produced in the same manner as that in Example 3, except that 1.5 parts by weight of the obtained sodium p-styrenesulfonate-styrene random copolymer was used as an influenza virus infection inhibitor for fiber processing. The fiber product that inhibits influenza virus infection contained 1 g/m² of the sodium p-styrenesulfonate-styrene random copolymer. The lightness value L* of the fiber product that inhibits influenza virus infection was 23.5.

### Comparative Example 1

81 parts by weight of sodium p-styrenesulfonate (manufactured by Tosoh Corporation under the trade name of “SPINOMAR NaSS,” the purity: 88.2% by weight), 200 parts by weight of ion exchanged water, 25 parts by weight of styrene monomers, and 300 parts by weight of ethanol (manufactured by Wako Pure Chemical Industries, Ltd. under the trade name of “86% ethanol-ME, denaturated”) were added into a 2 liter separable flask equipped with a stirrer, a condenser, and a thermometer. The gas in the separable flask was replaced by nitrogen gas while stirring, and then, the mixed liquid in the separable flask was heated and maintained at 78° C.

A polymerization initiator solution prepared by dissolving 1.5 parts by weight of potassium peroxodisulfate (manufactured by Wako Pure Chemical Industries, Ltd.) in 100 parts by weight of ion exchanged water was added into the separable flask over 15 minutes. Then, the styrene and the sodium p-styrenesulfonate were allowed to polymerize over a 5 hour period.

After that, the ion exchanged water in the separable flask was removed with an evaporator, and subsequently, the resulting precipitate was centrifuged while washing it with ion exchanged water to obtain a sodium p-styrenesulfonate-styrene random copolymer. The obtained sodium p-styrenesulfonate-styrene random copolymer contained 60% by weight of the sodium p-styrenesulfonate component and 40% by weight of the styrene component. The weight average molecular weight (Mw) of the sodium p-styrenesulfonate-styrene random copolymer was 120,000.

A fiber product that inhibits influenza virus infection was produced in the same manner as that in Example 3, except that 1.5 parts by weight of the obtained sodium p-styrenesulfonate-styrene random copolymer was used as an influenza virus infection inhibitor for fiber processing. The fiber product that inhibits influenza virus infection contained 1 g/m of the sodium p-styrenesulfonate-styrene random copolymer. The lightness value L* of the fiber product that inhibits influenza virus infection was 23.5.

The rubbing fastness and the effect of inhibiting influenza virus infection of the fiber products that inhibit influenza virus infection obtained in the examples and the comparative example were measured by a procedure described below and the results were shown in Table 1.

### (Rubbing Fastness)

The degree of staining of a white fabric in a dry state (dry test) and a wet state (wet test) caused by a woven fabric or a knitted fabric was determined by using a rubbing tester type II (Gakushin type) in accordance with a method for testing color fastness (JIS L0849). Grading was performed in each case on the basis of the Grey scale for assessing staining as described below.

### Dry Test

A: excellent—the grade was 4 or more.
B: good to average—the grade was 3.5.
C: bad—the grade was 3 or less.

### Wet Test

A: excellent—the grade was more than 2.
B: good to average—the grade was 2.
C: bad—the grade was less than 2.

### (Effect of Inhibiting Influenza Virus Infection)

### 1) Preparation of Virus-Containing Liquid

MDBK cells cultivated in a 10 cm dish were inoculated with an influenza virus. After the MDBK cells were cultivated at 37° C. for 1 hour, the culture supernatant (including a nonsensitized virus) was removed. A fresh DMEM medium was added to the 10 cm dish after removing the culture supernatant therein and cultivation was performed at 37° C. for 4 days. Then, a supernatant was collected and centrifuged at a rotation speed of 800 rpm for 5 minutes. The supernatant obtained after centrifugation was used as a virus-containing liquid.

### 2) Test Method

Square planar-shaped test pieces with 3 cm sides were cut out from the fiber products that inhibit influenza virus infection produced in the examples and the comparative example. 0.1 mL of the virus-containing liquid 20-fold diluted with a DMEM medium was dropped onto the test pieces and the test pieces were allowed to stand at room temperature for 3 minutes. After that, the virus-containing liquid on the test pieces was collected and the virus-containing liquid was diluted 10-fold, 100-fold, 1,000-fold, and 10,000-fold by mixing it with a DMEM medium to prepare a virus diluent. 0.1-mL aliquots of the virus diluent were inoculated into MDBK cells plated on a 96-well microplate and infected cells were cultivated at 37° C. for 1 hour. After cultivation, the culture supernatant (including a nonsensitized virus) was removed, 0.1 mL of a DMEM medium was added to the infected cells, and the infected cells were cultivated at 37° C. for 4 days. After the culture supernatant was removed, a DMEM medium containing 5% by weight of a water-soluble tetrazolium salt (manufactured by Dojindo Laboratories under the trade name of “WST-8”) was added to the infected cells, and the infected cells were cultivated at 37° C. for 3 hours. Absorbance at 450 nm was measured on a plate reader and the amount of viruses when 50% of cells were infected with a virus (TCID50: Tissue Culture Infectious Dose 50) was calculated on the basis of the percentage of viable cells in the infected cells, whereby a virus reduction rate was determined. The above-described procedure was performed on each of the eight test fabrics prepared in each of the examples and the comparative example. The arithmetic mean of the virus reduction rates of each of the test fabrics was used as “a virus reduction rate” and assessed on the basis of the following criterion.

A: 99% or more
B: 95% or more and less than 99%
C: 90% or more and less than 95%
D: less than 90%

TABLE 1

| | RUBBING FASTNESS | | EFFECT OF INHIBITING |
|---|---|---|---|
| | DRY | WET | INFLUENZA VIRUS |
| | TEST | TEST | INFECTION |
| EXAMPLE 1 | A | A | A |
| EXAMPLE 2 | A | A | A |
| EXAMPLE 3 | A | A | A |
| EXAMPLE 4 | A | A | A |
| EXAMPLE 5 | B | B | B |
| COMPARATIVE | C | C | C |
| EXAMPLE 1 | | | |

### INDUSTRIAL APPLICABILITY

The influenza virus infection inhibitor of the present invention can impart an effect of inhibiting influenza virus infection to a fiber product by nebulizing it onto, dispersing it in, applying it onto, or fixing it to the fiber product such as a fabric (for example, a woven fabric, a knitted fabric, a no, woven fabric, or the like), a carpet, a futon, a bed sheet, a curtain, a towel, clothing, or a stuffed toy. The influenza virus infection inhibitor of the present invention can be used favorably for a colored fiber product as well, since the inhibitor is excellent in rubbing fastness.

1. An influenza virus infection inhibitor for fiber processing, comprising a compound that inhibits influenza virus infection, wherein the compound has at least one of substituents with structural formulae represented by the respective general formulae (1) to (3) on a side chain of a linear macromolecule and contains not less than 70% by weight of a monomer component having at least one of the substituents with the structural formulae represented by the general formulae (1) to (3): 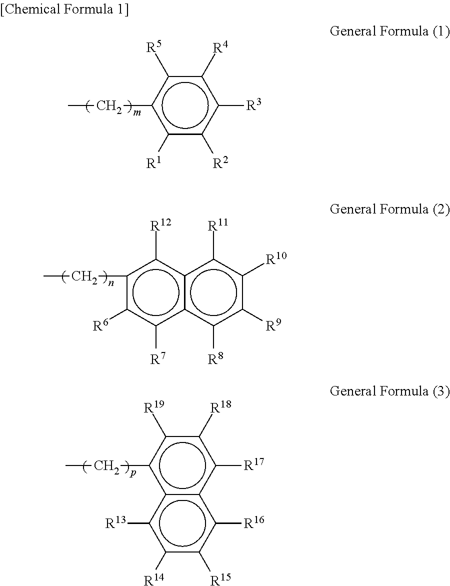
wherein m, n, and p each represent an integer of 0 to 2; R¹ to R¹⁹ each are any of hydrogen, a carboxy group, a sulfonic acid group, a carboxy group in salt form, a sulfonic acid group in salt form, a carboxy group in esterified form, and a sulfonic group in esterified form; at least one of R¹ to R⁵ is a carboxy group, a sulfonic acid group, a carboxy group in salt form, a sulfonic acid group in salt form, a carboxy group in esterified form, or a sulfonic group in esterified form; at least one of R⁶ to R¹² is a carboxy group, a sulfonic acid group, a carboxy group in salt form, a sulfonic acid group in salt form, a carboxy group in esterified form, or a sulfonic group in esterified form; and at least one of R¹³ to R¹⁹ is a carboxy group, a sulfonic acid group, a carboxy group in salt form, a sulfonic acid group in salt form, a carboxy group in esterified form, or a sulfonic group in esterified form.

2. A fiber product that inhibits influenza virus infection, comprising a fiber treated with the influenza virus infection inhibitor for fiber processing according to claim 1.

3. The fiber product that inhibits influenza virus infection according to claim 2, wherein a lightness value L* thereof is 80 or less.

4. The fiber product that inhibits influenza virus infection according to claim 2, wherein the fiber contains a polyester resin fiber.

5. A method for producing a fiber product that inhibits influenza virus infection, comprising: providing an influenza virus infection inhibitor for fiber processing containing a compound that inhibits influenza virus infection to the fiber product, thereby imparting an effect of inhibiting influenza virus infection to said fiber product to produce the fiber product that inhibits influenza virus infection, wherein the compound has at least one of substituents with structural formulae represented by the general formulae (1) to (3) on a side chain of a linear macromolecule and contains not less than 70% by weight of a monomer component having at least one of the substituents with the structural formulae represented by the general formulae (1) to (3), 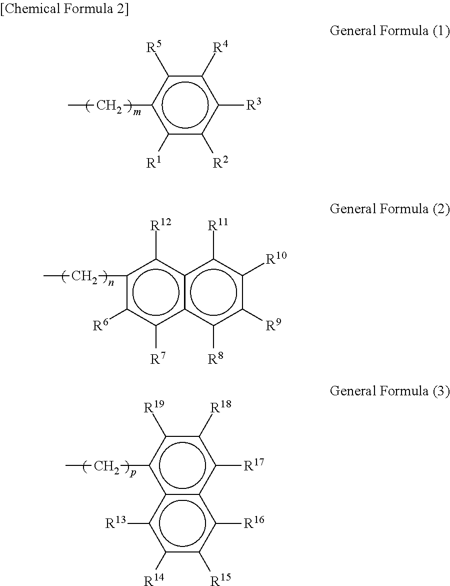
wherein m, n, and p each represent an integer of 0 to 2; R¹ to R¹⁹ each are any of hydrogen, a carboxy group, a sulfonic acid group, a carboxy group in salt form, a sulfonic acid group in salt form, a carboxy group in esterified form, and a sulfonic group in esterified form; at least one of R¹ to R⁵ is a carboxy group, a sulfonic acid group, a carboxy group in salt form, a sulfonic acid group in salt form, a carboxy group in esterified form, or a sulfonic group in esterified form; at least one of R⁶ to R¹² is a carboxy group, a sulfonic acid group, a carboxy group in salt form, a sulfonic acid group in salt form, a carboxy group in esterified form, or a sulfonic group in esterified form; and at least one of R¹³ to R¹⁹ is a carboxy group, a sulfonic acid group, a carboxy group in salt form, a sulfonic acid group in salt form, a carboxy group in esterified form, or a sulfonic group in esterified form.

6. (canceled)

7. (canceled)

8. The fiber product that inhibits influenza virus infection according to claim 3, wherein the fiber contains a polyester resin fiber.
